(19) United States
(12) Patent Application Publication
(10) Pub. No.: US 2009/0071343 A1
(43) Pub. Date: Mar. 19, 2009

(54) French press spent grounds keeper

(76) Inventor: Janice M. Helde, Shoreline, WA (US)

Correspondence Address: Janice M. Helde, 922 NE 150th St., Shoreline, WA, 98155, US

(21) Appl. No.: 11/901,738

(22) Filed: Sep. 19, 2007

(51) Int. Cl. A47J 31/44; A47J 31/38

(52) U.S. Cl. 99/289 R; 99/297

(57) ABSTRACT

A method of removing coffee grounds or solid materials from a French press coffee maker by inserting an apparatus consisting of a woven material creating a basket that fits the bottom of the coffee maker and is supported by four vertical evenly spaced bars, held together by a band at the top. The apparatus fits snuggly inside a French press and when removed from the French press it removes all solid materials inside the French press and leaves the liquid within the press.

The present invention is in the field of French press coffee makers. This apparatus is placed inside the coffee maker for the purpose of easily removing coffee grounds, or other solid materials, from the coffee maker, leaving only liquid inside.

### BACKGROUND

The French press coffee process entails coffee grounds and hot water to be placed into the press with no separation between the two ingredients. Likewise, when these two ingredients are removed, they are removed together. Removing these two ingredients together can create a liquid mess of coffee grounds. This invention allows the ingredients to be placed into the press together, but allows the coffee grounds, or other solid materials, to be removed separate from the liquid. The goal of the invention is to enhance cleaning process of the press and allow the easy disposal of the spent grounds or other solid materials.

### SUMMARY

A solution to remove the used or spent grounds, or other solid materials in a French press coffee maker is to place an apparatus in the bottom of the press prior to placing the coffee grounds and hot water into the press.

The Grounds Keeper is a removable apparatus that fits snuggly inside the press. The top of the apparatus is a band that fits approximately ¼ inch from the top of the press, the band is connected to four vertical, evenly spaced bars that slide next to the side of the press. The four bars connect to a circular screen which rests slightly off the bottom of the press. The screen has approximately ¼ inch high sides that create a basket to hold the coffee grounds.

The Grounds Keeper is placed inside a French press. The press is used in its normal manner and when ready to be cleaned, the Grounds Keeper is removed from the press taking the spent grounds with it. The grounds can be discarded separate from any liquid remaining in the press.

### BRIEF DESCRIPTION OF FIGURES

FIG. 1—illustrate the Grounds Keeper

FIG. 2—illustrate top view of the Grounds Keeper

FIG. 3—illustrate bottom view of the Grounds Keeper

FIG. 4—illustrate vertical section through center (solid lines) inside a generic French press coffee maker (light shadow lines).

### DETAILED DESCRIPTION

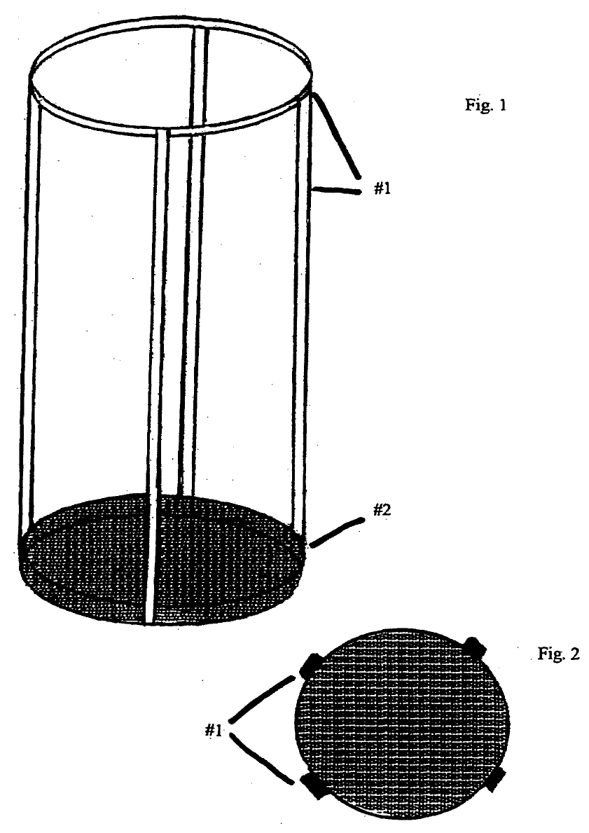

FIG. 1—illustrates the design of the Grounds Keeper. The top band (#1) and four vertical bars (#2) conform in thickness. The vertical bars are evenly placed and attach to a screen (#3) forming a woven basket intended to hold coffee grounds.

FIG. 2—illustrates the Grounds Keeper looking down inside a coffer maker. The top band (#1) fits against the side of the coffee maker and is attached to the four vertical bars (#2) which hold the woven basket (#3) to the bottom of the coffee maker.

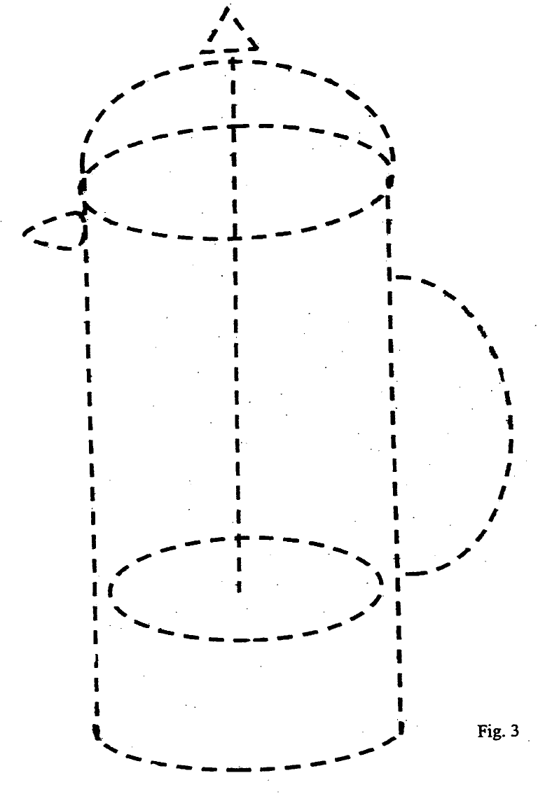

FIG. 3—illustrates the bottom view of the Grounds Keeper. The four vertical bars (#2) hold the woven basket (#3) in place.

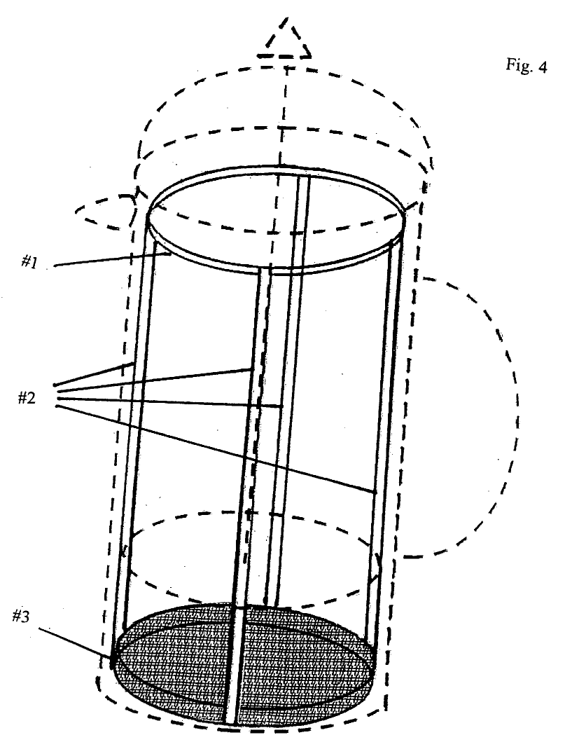

FIG. 4—illustrates a vertical cross section through the center of a Grounds Keeper inside a coffee maker. The top band (#1) fits approximately ¼ inch from the top of the coffee maker. The four vertical bars (#2) attach to the top band and fit snuggly against the sides and are thin enough to allow the plunger to slide past without interference. The vertical bars (#2) hold the woven basket (3) which sits on the bottom of the coffee maker.

1. A removable apparatus that is placed inside a French press coffee maker prior to placing coffee grounds or other solid materials into the coffee maker, for the purpose of allowing the coffee grounds or other solid materials to be removed easily from the coffee maker and allow the liquid to remain the press.
